(19) United States
(12) Patent Application Publication
(10) Pub. No.: US 2010/0016114 A1
(43) Pub. Date: Jan. 21, 2010

(54) Modular robot control system

(76) Inventor: Din-Shan Chang, Gueishan Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/219,257

(22) Filed: Jul. 18, 2008

(51) Int. Cl. F16H 48/06

(52) U.S. Cl. 475/149; 901/23

(57) ABSTRACT

A modular robot control system includes at least one actuator and circuit board. The actuator includes a hollow casing with an opening, a flywheel, a motor, a fixed gear, a rotating gear and a top cap sealing the opening. Flywheel is mounted between the top cap and the casing. A first and a second planet gears are mounted outside the flywheel rotatingly. The motor received in the flywheel has a rotor shaft on which the flywheel is mounted rotatingly. The circuit board is mounted with the casing and connected with the motor. The fixed gear is fixed in the flywheel and engages with the first planet gear. The rotating gear is connected inside the top cap and engages with the second planet gear. Accordingly, signal disturbance and noise produced during the operation of the robot control system of the present invention are low.

### BACKGROUND OF THE INVENTION

1. Field of the Invention

The present invention relates to a robot control system, especially to a robot control system having actuators with internal motors.

2. Description of Related Art

As shown in FIG. 1, a conventional robot control system generally includes a plurality of controllers 1a, motor drivers 2a, actuator 3a and cables 4a. The robot control system is mounted on a robot, and the cables 4a are connected between the controllers 1a, the motor drivers 2a, and the actuator 3a. The larger the number of actuators 3a, the more cables 4a are contained in the system. The robot control system having many cables 4a is a complex structure, so it is not convenient to assemble the robot control system having many actuators 3a. In addition, the distance between the actuators 3a and the controller 1a is long, so that signal disturbance and noise produced during the operation of the robot control system are high.

Hence, the inventors of the present invention believe that the shortcomings described above are able to be improved and finally suggest the present invention which is of a reasonable design and is an effective improvement.

### SUMMARY OF THE INVENTION

An object of the present invention is to provide a modular robot control system with a simple structure, a small number of cables, and with low disturbance and noise produced during operation of the robot control system.

To achieve the above-mentioned objects, a modular robot control system in accordance with the present invention is provided. The modular robot control system comprises at least one actuator, wherein the actuator includes a hollow casing with an opening, a flywheel mounted in the casing, a gear shaft connected to an outer surface of the flywheel, a first planet gear and a second planet gear mounted rotatingly on the gear shaft, a motor received in the flywheel and having a rotor shaft on which the flywheel is mounted rotatingly, a fixed gear mounted between the outer surface of the flywheel and an inner surface of the casing, the fixed gear fixed on an inner wall of the casing and engaging with the first planet gear, a rotating gear rotatingly surrounding the flywheel and engaging with the second planet gear, a top cap covering the casing and sealing the opening, the rotating gear connected to an inner wall of the top cap, wherein when the rotating gear turns, the rotating gear drives the top cap to turn, and a plurality of balls annularly distributed between the casing and the flywheel and between the casing and the top cap; and at least one circuit board, wherein the circuit board is mounted on a surface of the casing, the circuit board has a motor driving chip and a motor controlling chip, the motor driving chip is connected with the motor, and the motor controlling chip is connected with the motor driving chip.

The efficacy of the present invention is as follows: since the motor is mounted in the inner surface of the casing and the circuit board is mounted on the surface of the casing, the numbers of cables of the robot control system can be decreased, and the distance between the actuator and the circuit board can be short. Whereby it is convenient for assemble the robot control system in a robot, and signal disturbance and noise produced during the operation of the robot control system are low. Furthermore, the internal components in the actuator have simple structures, so the noise and the friction force produced during the operation of the actuator is low, and the low friction force ensure that the loss of the output torque force decrease relatively.

### BRIEF DESCRIPTION OF THE DRAWINGS

FIG. 1 is a block diagram of a conventional robot control system;

FIG. 2 is a block diagram of a modular robot control system according to the present invention;

FIG. 3 is an assembled perspective view of a actuator of the modular robot control system according to the present invention;

FIG. 4 is an exploded perspective view of the actuator according to the present invention;

FIG. 5 is a cross-sectional view of the actuator according to the present invention;

FIG. 6 is an assembled view of a top cap of the actuator according to the present invention;

FIG. 7 is an exploded perspective view of another embodiment of the actuator according to the present invention;

FIG. 8 is a cross-sectional view of another embodiment of the actuator according to the present invention;

FIG. 9 is an assembled view of a bottom cap of the actuator according to the present invention;

FIG. 10 is a schematic view of the actuator according to the present invention, in motion;

FIG. 11 is a first schematic view showing the engagement of the first planet gears, the second planet gears, the rotating gear and the fixed gear of the present invention;

FIG. 12 is a second schematic view showing the engagement of the first planet gears, the second planet gears, the rotating gear and the fixed gear of the present invention;

FIG. 13 is a third schematic view showing the engagement of the first planet gears, the second planet gears, the rotating gear and the fixed gear of the present invention; and

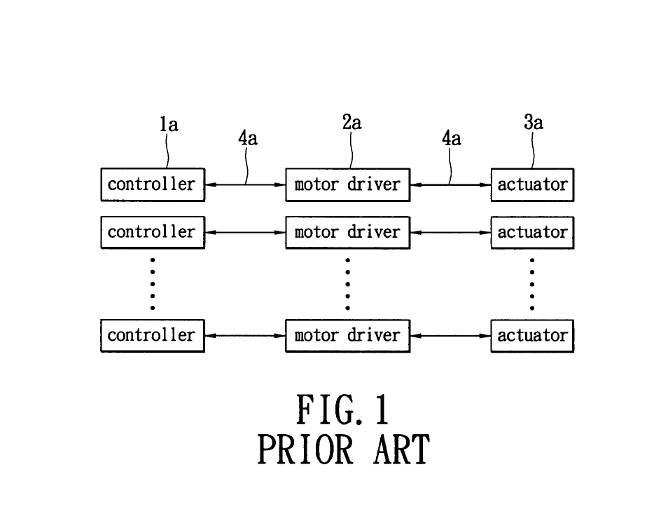

### DETAILED DESCRIPTION OF THE PREFERRED EMBODIMENTS

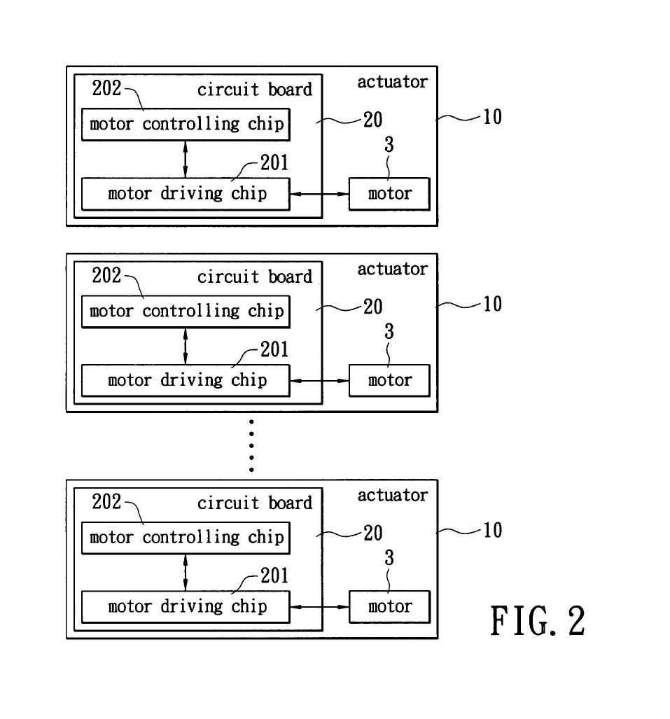

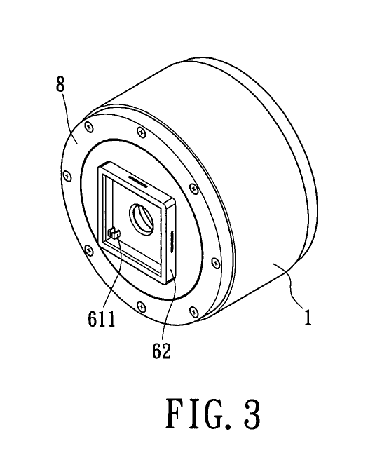

As shown in FIG. 2 and FIG. 3, a modular robot control system according to the present invention includes a plurality of actuators 10 and a plurality of circuit boards 20. The circuit boards 20 are mounted on a surface of the actuators 10 respectively, and the actuators 10 is mounted on a robot (not shown). Each circuit board 20 has a motor driving chip 201 and a motor controlling chip 202, each motor driving chip 201 is connected with each actuator 10, and each motor controlling chip 202 is connected with each motor driving chip 201. A control center transmits signals to the circuit boards 20 mounted on the actuators 10 by cables or wireless technology to control the operation of the robot (not shown).

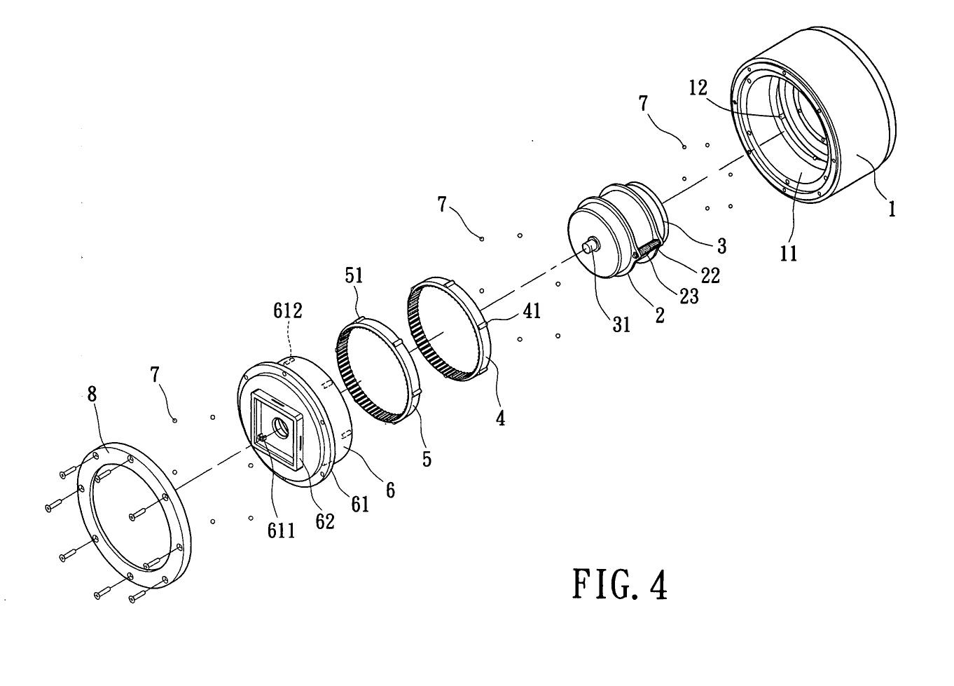

As shown in FIG. 3 and FIG. 4, the actuator 10 according to the present invention includes a hollow casing 1, a flywheel 2, a motor 3, a fixed gear 4, a rotating gear 5, a top cap 6 and a plurality of balls 7. The casing 1 has an opening 11, and the flywheel 2, the motor 3, the fixed gear 4 and the rotating gear 5 are received in the casing 1. Each circuit board 20 is mounted on a surface of the casing 1, and each motor driving chip 201 is connected with each motor 3 electrically.

Two gear shafts 21 are connected to the outer surface of the flywheel 2. A fastening ring 211 is mounted on one end of each gear shaft 21 to fasten the gear shaft 21 on the surface of the flywheel 2, and a gear shaft base 212 is formed on the other end of each gear shaft 21 and embedded in the flywheel 2.

A first planet gear 22 and a second planet gear 23, which have the same number of teeth, are mounted on each gear shaft 21 rotatingly. Two first bearings 24 are respectively mounted on two corresponding ends of each gear shaft 21. The first planet gear 22 and the second planet gear 23 are located between the two first bearings 24. The corresponding two ends of each gear shaft 21 further pass through two wear resistant pieces 25 which are located between the two first shafts 24 and the flywheel 2, respectively. The flywheel 2 has a protruding portion 26 protruding from its outer surface.

The motor 3 is received in the flywheel 2 and includes a rotor shaft 31 extending out of the protruding portion 26 of the flywheel 2. The rotor shaft 31 is rotatingly connected with a second bearing 32 which is mounted on the top cap 6. The flywheel 2 is mounted on the rotor shaft 31 rotatingly via the second bearing 32. The second bearing 32 abuts against the protruding portion 26. The rotor shaft 31 further passes through a gasket 33 located between the inner surface of the flywheel 2 and the outer surface of the motor 3.

A plurality of long-strip-shaped grooves 12 is annularly arranged at intervals in the inner wall of the casing 1. The fixed gear 4 surrounding the flywheel 2 has a plurality of protruding strips 41 which are formed at intervals in the outer wall of the fixed gear 4, corresponding to the grooves 12. The protruding strips 41 engage with the grooves 12 so that the fixed gear 4 is fixed in the casing 1 and engages with the two first planet gears 22. The rotating gear 5 is rotatably mounted between the outer surface of the flywheel 2 and the inner surface of the top cap 6 and engages with the two second planet gears 23. When turning, the second planet gears 23 drive the rotating gear 5 to turn synchronously. The teeth of the fixed gear 4 must be less than that of the rotating gear 5 to produce a gear reduction ratio, thereby the rotor shaft 31 can decelerate.

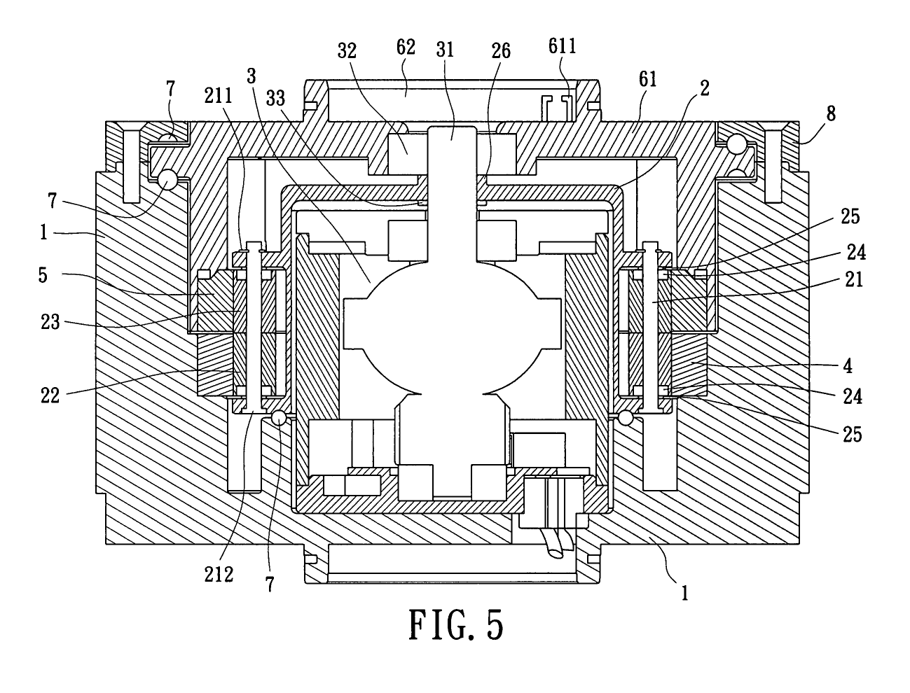

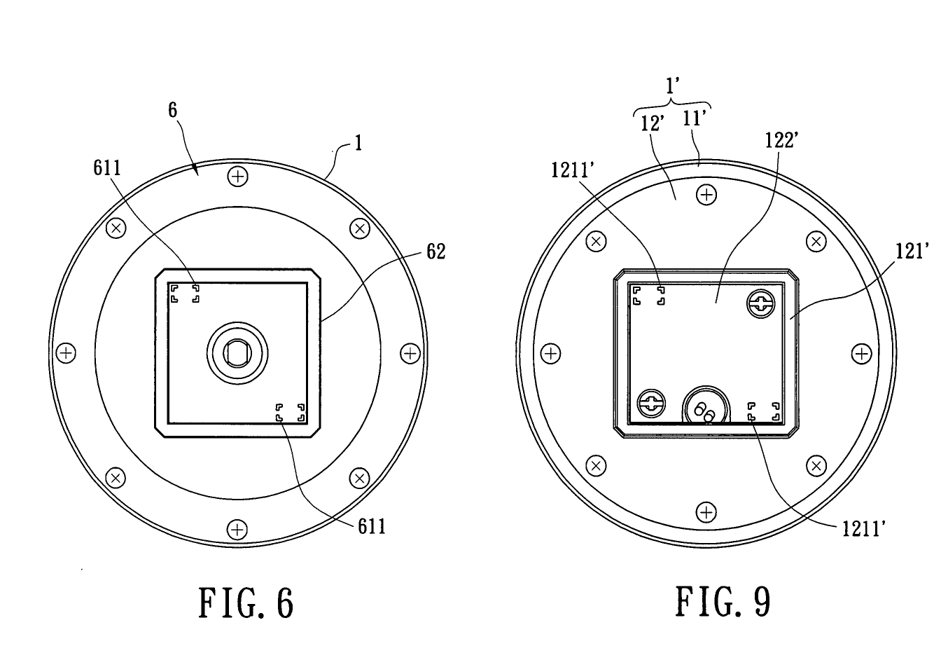

As shown in FIG. 5 and FIG. 6, the top cap 6 includes a first base portion 61 and a first plate body 62. The first base portion 61 has two first tenons 611 which are jointed on two diagonal positions of the first plate body 62, respectively. The first base portion 61 of the top cap 6 covers the casing 1 and seals the opening 11. The first base portion 61 extends into the casing 1 and has a plurality of long-strip-shaped grooves 612 annularly arranged at intervals in the inner wall thereof. The rotating gear 5 has a plurality of protruding strips 51 formed at intervals in the outer wall thereof, corresponding to the grooves 612. The protruding strips 51 engage with the grooves 612 so that the rotating gear 5 is connected to the inner wall of the top cap 6. When the rotating gear 5 turns, it drives the top cap 6 to turn synchronously.

As shown in FIG. 3 and FIG. 4, the casing 1, the first planet gears 22, the second planet gears 23, the fixed gear 4, the rotating gear 5 and the top cap 6 are made of engineering plastics. The balls 7 are made of steel and have great supporting forces and high reliability. The balls 7 are annularly distributed between the casing 1 and the flywheel 2 and between the casing 1 and the top cap 6. The balls 7 are used as sliding mediums, which are coated with lubricating oil to reduce friction forces between the balls and the casing 1, the flywheel 2 and the top cap 6. The present invention further includes a fixed ring 8 which is locked on the outer surface of the casing 1 via grub screws with hexagon holes to surround the top cap 6, and the balls 7 are annularly distributed between the top cap 6 and the fixed ring 8.

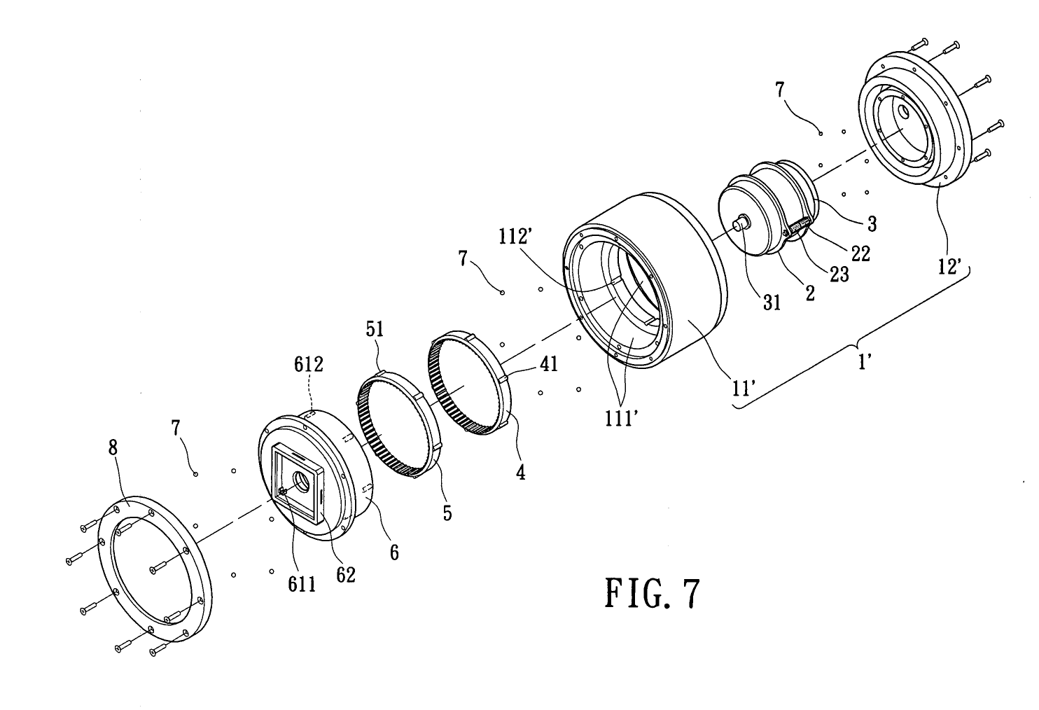

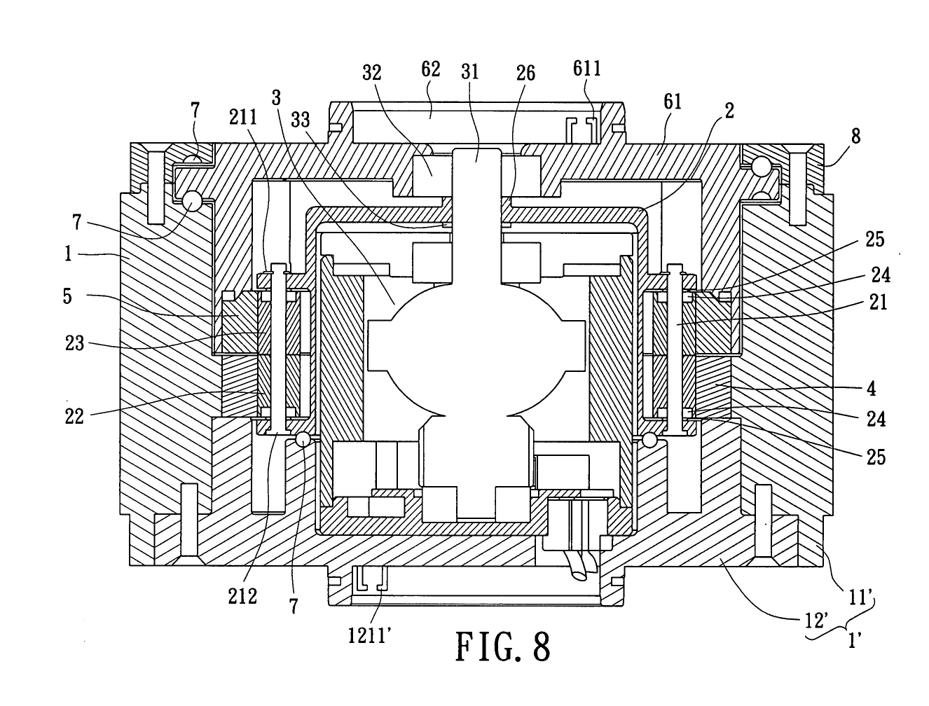

As shown in FIGS. 7 and 8, in another embodiment, the casing 1′ includes a hollow body 11′ and a bottom cap 12′. The hollow body 11′ has two openings 111′ respectively formed in two corresponding ends thereof. A plurality of long-strip-shaped grooves 112′ is annularly arranged at intervals in the inner wall of the hollow body 11′, corresponding to the protruding strips 41. The protruding strips 41 of the fixed gear 4 engage with the grooves 112′ to fix the fixed gear 4 in the hollow body 11′. The bottom cap 12′ is fixed on one of the openings 111′ of the hollow body 11′ and seals the opening 111′. The bottom cap 12′ includes a second base portion 121′ and a second plate body 122′. The second base portion 121′ has two second tenons 1211′ which are jointed on two diagonal positions of the second plate body 122′, respectively. The motor 3 is locked on the other diagonal positions of the second plate body 122′ via screws. The balls 7 are annularly distributed between the hollow body 11′ and the top cap 6 and between the bottom cap 12′ and the flywheel 2. The fixed ring 8 is locked on the outer surface of the hollow body 11′ via grub screws with hexagon holes.

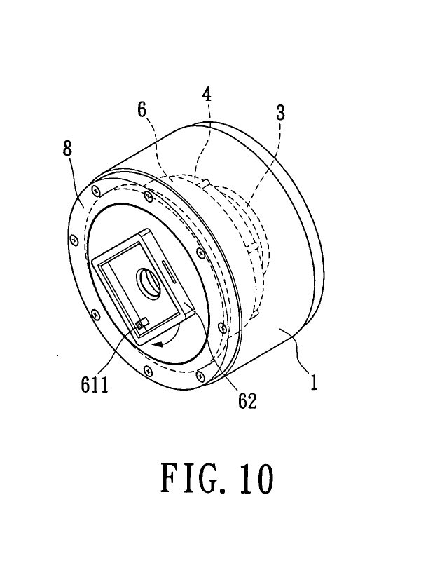

As shown in FIG. 5 and FIG. 10, when the motor 3 is electrically connected to an external power source (not shown), the rotor shaft 31 of the motor 3 starts to turn and drives the flywheel 2 to turn. When the fly wheel 2 turns, the first planet gear 22 and the second planet gear 23 respectively engaging with the fixed gear 4 and the rotating gear 5 will turn on the gear shaft 21. At this time, the fixed gear 4 is stationary in the casing 1 and the second planet gear 23 drives the rotating gear 5 to turn. When the rotating gear 5 turns, it will drive the top cap 6 to turn synchronously. By the way, a screw may be connected with the output end (the top cap 6) of the train mechanism and driven to move linearly and telescopically (not shown) by the train mechanism.

It is worthwhile to mention that the two first planet gears 22, the two second planet gears 23, the fixed gear 4 and the rotating gear 5 have specially designed tooth shapes. Otherwise, when the first planet gears 22 and the second planet gears 23 turn, the fixed gear 4 and the rotating gear 5 cannot be in the correct states, that is, one gear is stationary and the other gear is in motion. The design for the tooth shapes of the gears is as follows:

1. The first planet gears 22 and the second planet gears 23 have convex teeth with the same tooth shape, of which side appearances are slightly shaped like an isosceles trapezoid.

2. Side appearances of convex teeth of the fixed gear 4 and the rotating gear 5 are slightly shaped like isosceles trapezoids, and the tooth width of the convex teeth of the fixed gear 4 is slightly greater than that of the convex teeth of the rotating gear 5.

3. The maximum tooth width of the convex teeth of the fixed gear 4 and the rotating gear 5 is greater than that of the convex teeth of the first planet gears 22 and the second planet gears 23.

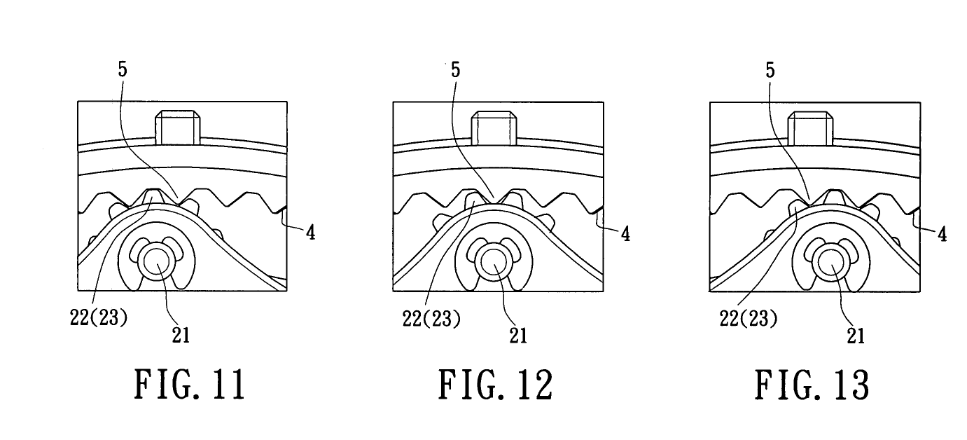

As shown in FIG. 11, the convex teeth of the first planet gears 22 and the second planet gears 23 respectively extend into tooth seams between adjacent convex teeth of the fixed gear 4 and the rotating gear 5. The tops of the convex teeth of the first planet gears 22 and the second planet gears 23 respectively collide with the bottoms of the tooth seams of the fixed gear 4 and the rotating gear 5. As shown in FIG. 12, then the side portions of the convex teeth of the first planet gears 22 and the second planet gears 23 respectively collide with the side portions of the convex teeth of the fixed gear 4 and the rotating gear 5. As shown in FIG. 13, finally, the side portions of the convex teeth of the first planet gears 22 and the second planet gears 23 respectively move to the tops of the convex teeth of the fixed gear 4 and the rotating gear 5 along the side portions of the convex teeth of the fixed gear 4 and the rotating gear 5, thereby the convex teeth of the first planet gears 22 and the second planet gears 23 respectively extend into next tooth seams of the fixed gear 4 and the rotating gear 5.

Consequently, the advantages of the modular robot control system of the present invention are as follows:

1. Since the motor 3 is mounted in the inner surface of the casing 1 and the circuit board 20 is mounted on the surface of the casing 1, the actuator 10 has a small volume, the numbers of cables of the robot control system can be decreased, and the distance between the actuator 10 and the circuit board 20 is short. Whereby it is convenient for assemble the robot control system in a robot, and signal disturbance and noise produced during the operation of the robot control system are low. Furthermore, the internal components in the actuator 10 have simple structures, so the noise and the friction force produced during the operation of the actuator 10 is low, and the low friction force ensure that the loss of the output torque force decrease relatively.

2. The casing 1, the first planet gears 22, the second planet gears 23, the fixed gear 4, the rotating gear 5 and the top cap 6 are made of engineering plastics which has a low cost, high plasticity and high intensity and ensures that the noise cause by friction and collision of the components is low.

3. The protruding portion 26 is formed to avoid direction friction between the second bearing 32 and the flywheel 2.

4. The wear resistant pieces 25 are mounted to reduce the friction force between the first bearing 24 and the flywheel 2.

5. The gasket 33 reduces the friction force produced when the flywheel 2 and the rotor shaft 31 contact with each other.

What are disclosed above are only the specification and the drawings of the preferred embodiments of the present invention and it is therefore not intended that the present invention be limited to the particular embodiments disclosed. It will be understood by those skilled in the art that various equivalent changes may be made depending on the specification and the drawings of the present invention without departing from the scope of the present invention.

What is claimed is:

1. A modular robot control system, comprising:
at least one actuator, wherein the actuator includes a hollow casing with an opening, a flywheel mounted in the casing, a gear shaft connected to an outer surface of the flywheel, a first planet gear and a second planet gear mounted rotatingly on the gear shaft, a motor received in the flywheel and having a rotor shaft on which the flywheel is mounted rotatingly, a fixed gear mounted between the outer surface of the flywheel and an inner surface of the casing, the fixed gear being fixed on an inner wall of the casing and engaging with the first planet gear, a rotating gear rotatingly surrounding the flywheel and engaging with the second planet gear, a top cap covering the casing and sealing the opening, wherein the rotating gear is connected to an inner wall of the top cap, and the rotating gear drives the top cap to turn when the rotating gear is turning, a plurality of balls annularly distributed between the casing and the flywheel and between the casing and the top cap, and
at least one circuit board, wherein the circuit board is mounted on a surface of the casing, the circuit board has a motor driving chip and a motor controlling chip, the motor driving chip is connected with the motor, and the motor controlling chip is connected with the motor driving chip.

2. The modular robot control system as claimed in claim 1, wherein the rotating gear has more teeth than the fixed gear.

3. The modular robot control system as claimed in claim 1, wherein two first bearings are rotatingly mounted on two ends of the gear shaft respectively, and the first planet gear and the second planet gear are located between the two first bearings.

4. The modular robot control system as claimed in claim 1, wherein the rotor shaft is rotatingly connected with a second bearing, which is mounted on the top cap, the flywheel has a protruding portion protruding from its outer surface, and the rotor shaft extends out of the protruding portion and the second bearing abuts against the protruding portion.

5. The modular robot control system as claimed in claim 1, wherein the balls are made of steel and coated with lubricating oil.

6. The modular robot control system as claimed in claim 1, wherein the top cap, the casing, the first planet gear, the second planet gear, the fixed gear and the rotating gear are made of engineering plastics.

7. The modular robot control system as claimed in claim 1, wherein the rotor shaft passes through a gasket located between the flywheel and the motor.

8. The modular robot control system as claimed in claim 1, wherein a fastening ring is mounted on one end of the gear shaft to fasten the gear shaft on the flywheel, and a gear shaft base is formed on the other end of the gear shaft and embedded in the flywheel.

9. The modular robot control system as claimed in claim 3, wherein the gear shaft passes through two wear resistant pieces which are located between the first bearings and the flywheel, respectively.

10. The modular robot control system as claimed in claim 1, wherein the top cap includes a first base portion and a first plate body, and the first base portion has two first tenons which are respectively jointed on the first plate body.

11. The modular robot control system as claimed in claim 1, further comprising a fixed ring fixed on an outer surface of the casing and surrounding the top cap, the balls distributed between the fixed ring and the top cap.

12. The modular robot control system as claimed in claim 1, wherein the casing includes a hollow body and a bottom cap, and the hollow body has two openings respectively formed in two corresponding ends thereof, the bottom cap is fixed on one of the openings of the hollow body and seals the opening, and the balls are annularly distributed between the hollow body and the top cap and between the bottom cap and the flywheel.

13. The modular robot control system as claimed in claim 12, wherein the bottom cap includes a second base portion and a second plate body, and the second base portion has two second tenons which are respectively jointed on the second plate body and the motor is fixed on the second plate body.

14. The modular robot control system as claimed in claim 12, further comprising a fixed ring fixed on an outer surface of the hollow body.
